(19) United States
(12) Patent Application Publication
(10) Pub. No.: US 2008/0301895 A1
(43) Pub. Date: Dec. 11, 2008

(54) Protective Cap for a Window Wiper Shaft

(75) Inventor: Roland Bohn, Buehl (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/159,044

(22) PCT Filed: Nov. 15, 2006
(86) PCT No.: PCT/EP2006/068513

§ 371 Date: Jun. 24, 2008

(30) Foreign Application Priority Data
Dec. 28, 2005 (DE) 102005062719.6

(51) Int. Cl. B60S 1/34

(52) U.S. Cl. 15/250.001

(57) ABSTRACT

The invention relates to a protective cap (20) for a wiper shaft (8) driven by a wiper drive (6), pertaining to a window wiper arrangement, especially a windscreen wiper system (4) of a motor vehicle. Said protective cap comprises an opening (36) for the wiper shaft (8), a ring seal (34) inserted into the opening (36), and a peripheral dust lip (32) on the front end (30) opposing the wiper drive (6). A supporting bearing (40) for supporting the protective cap (20) is provided on a peripheral surface of the wiper shaft (8).

### BACKGROUND OF THE INVENTION

The invention relates to a protective cap for a wiper shaft driven by a wiper drive of a window wiper arrangement, in particular a rear window wiper arrangement of a motor vehicle, as well as a wiper drive for a window wiper arrangement.

Rear window wiper arrangements of motor vehicles generally comprise, as a wiper drive, a wiper motor accommodated in the interior of the motor vehicle comprising a flange-mounted step-down gearing as well as a wiper shaft driven via the step-down gearing by the wiper motor which projects outwardly through an installation opening in a bodywork part arranged below or above the rear window or through an installation opening in the rear window itself and at its free end bears a wiper arm resting on the rear window. In order to prevent the penetration of moisture along the wiper shaft into the interior of the motor vehicle, with rear window wiper arrangements currently produced by the applicant, a protective cap is pushed onto the wiper shaft and non-positively and/or positively connected to a gear housing of the wiper drive. The protective cap comprises a through-opening for the wiper shaft and is fitted with an annular seal inserted into the through-opening and bearing against the wiper shaft. The protective cap extends in the region of the installation opening through a weather-strip fixed in the installation opening, which bears against the outer peripheral surface of the protective cap. Moreover, the protective cap is provided on its front end remote from the wiper drive with a peripheral dust lip, which prevents penetration of dirt into the protective cap.

When the protective cap during the mounting of the wiper drive, for example as a result of an extreme tolerance position, is unilaterally pressed against the weather-strip inserted into the installation opening, a radial force acts on the protective cap. As, in the region of the annular seal and in the region of the easily deformable dust lip which offers little resistance, the protective cap only bears against the wiper shaft, the annular seal incorporated in the protective cap is unilaterally loaded by the radial force introduced via the annular seal into the wiper shaft. This in turn leads to unilateral wear of the annular seal which shortens the operational life thereof, and may result in penetration of moisture past the annular seal into the interior of the motor vehicle.

### SUMMARY OF THE INVENTION

The protective cap according to the invention and the wiper drive according to the invention have the advantage, however, that radial forces acting on the protective cap are introduced into the wiper shaft via the additional support bearing, so that unilateral loading of the annular seal and thus wear thereof may be avoided.

The additional support bearing is preferably arranged between the dust lip and the annular seal, but may also be arranged on the side of the annular seal remote from the dust lip.

In order to accommodate the additional support bearing along the predetermined length of the protective cap, said support bearing is preferably directly adjacent to the annular seal, whilst expediently it is a short distance from the dust lip, as otherwise a sufficient flexibility of the dust lip may not be ensured.

According to a first embodiment of the invention, the support bearing consists of a separate bearing element, introduced around the through-opening into a complementary cross-sectional widening of the protective cap, made of an inflexible rigid material, preferably made from corrosion-resistant material suitable as a bearing for the wiper shaft, such as for example sintered bronze or oil-impregnated sintered steel, so that the protective cap may be supported via the support bearing on the rotating wiper shaft and radial forces occurring without a deformation of the protective cap may be introduced into the wiper shaft via the support bearing.

The cross-sectional widening of the through-opening, used to receive the bearing element, is expediently open toward an adjacent larger inner recess of the protective cap receiving the annular seal, so that the bearing element may be inserted into the protective cap in front of the annular seal from the side adjacent to the wiper drive along the through-opening.

A second variant of the invention provides, however, that the support bearing forms an integral part of the protective cap, which in a similar manner to the aforementioned bearing element also extends over an axial length of the protective cap which is sufficient for supporting and/or force transmission, preferably at least over a length of approximately 5 to 10 mm, and with its inner peripheral surface bears against the adjacent outer peripheral surface of the wiper shaft.

### BRIEF DESCRIPTION OF THE DRAWINGS

The invention is described in more detail hereinafter in three embodiments with reference to the accompanying drawings, in which:

FIG. 1 shows a partial sectional side view of a part of the rear window wiper arrangement of a motor vehicle comprising a protective cap pushed onto the wiper shaft of the wiper drive;

FIG. 2 shows an enlarged sectional view of a part of the wiper drive and the protective cap;

FIG. 3 shows an enlarged sectional view of a part of a wiper shaft with an alternative protective cap;

FIG. 4 shows an enlarged sectional view of a part of a wiper shaft with an alternative protective cap.

### DETAILED SUMMARY

The rear window wiper arrangement 4 shown only partially in the drawings, and used for cleaning a rear window 2 of a passenger motor vehicle, substantially consists of a wiper drive 6 accommodated in the interior of the passenger motor vehicle, the wiper shaft 8 thereof being guided through an installation opening 9 in the rear window 2 (or out of an external bodywork panel) out of the passenger motor vehicle to the outer face of the rear window 2, as well as a wiper arm (not shown) fixed in rotation outside the passenger motor vehicle in the known manner and releasably fastened to the free end of the wiper shaft 8.

The wiper drive 6 also comprises in the known manner a direct-current wiper motor (not shown) as well as a step-down gearing 10 flange-mounted thereto, the output shaft thereof forming the wiper shaft 8.

As is shown best in FIG. 2, the wiper shaft 8 extends out of the gear 10 through a tubular connecting piece 12 which is formed on a gear housing 14 of the step-down gearing 10 and is provided in its free front end 16 with a sintered bearing (bearing element) 18 bearing against the peripheral surface of the wiper shaft 8.

In order to prevent the penetration of moisture along the wiper shaft 8 into the interior of the passenger motor vehicle, the wiper drive 6 is provided with a protective cap 20 positioned and/or pushed onto the wiper shaft 8, which penetrates a rubber seal (grommet) 22 inserted into the installation opening 9 and provided with a passage for the protective cap 20.

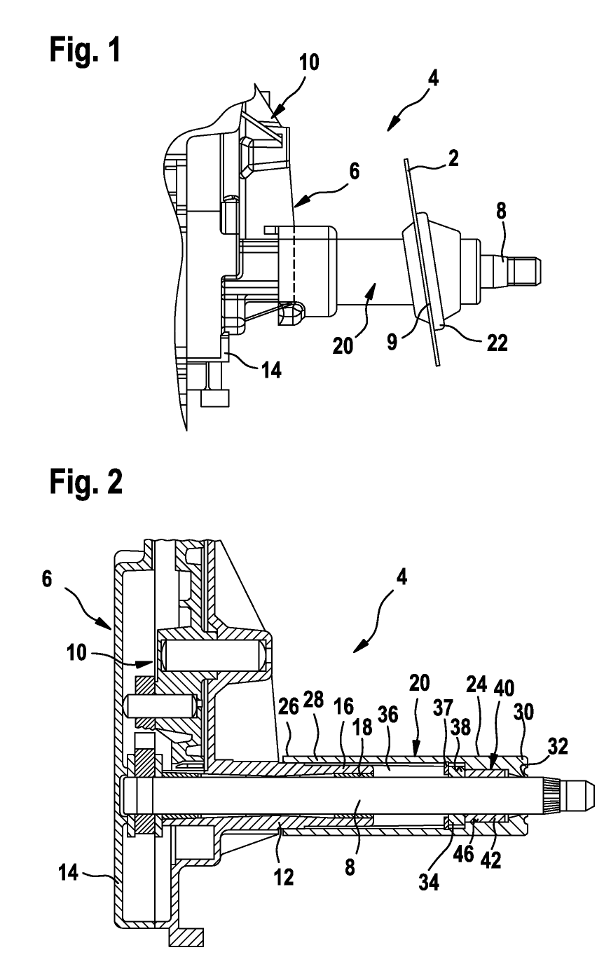

As is shown best in FIG. 2, the protective cap 20, produced for example by injection molding from plastics, has a cylindrical peripheral surface 24 which forms a bearing surface for the rubber seal 22 (FIG. 1) inserted into the installation opening 9. The protective cap 20 has an open front end 26 on the drive side and a peripheral wall 28 becoming thinner toward said front end 26, which is fixedly positioned onto an external conical peripheral surface of the connecting piece 12, and is secured thereto by a non-positive and/or frictional connection. The partially closed opposing front end 30 of the protective cap 20 has an outlet for the wiper shaft 8 which is defined by a peripheral dust lip 32 bearing against the peripheral surface of the wiper shaft 8.

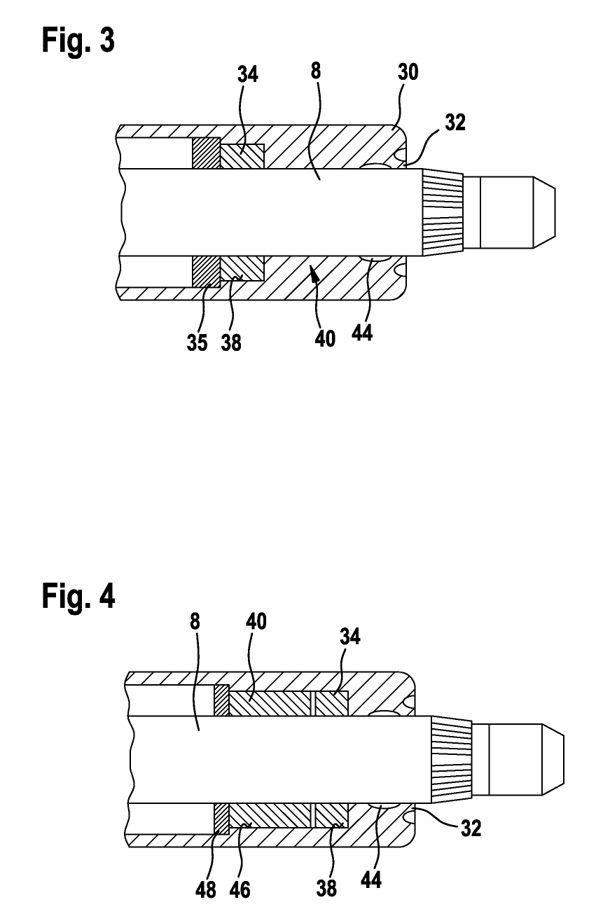

Between the free front end 16 of the connecting piece 12 and the dust lip 32, an annular seal 34 is introduced into a through-opening 36 for the wiper shaft 8 recessed in the protective cap 20. The annular seal 34 bears against the cylindrical peripheral surface of the wiper shaft 8 and is secured by a pressed-in, clipped-in or caulked steel disc 48 (FIG. 4), an ultrasound welded plastics ring 35 (FIG. 3), or a locking ring 37 (FIG. 2) in a recess 38 open toward the front end 26 of the protective cap 20, of reduced internal diameter.

In order to avoid unilateral loading of the annular seal 34 and thus uneven wear thereof, which for example may be produced by a distorted installation of the wiper shaft 8 with the protective cap 20 and a unilateral pressure produced thereby of the rubber seal 22 on the peripheral surface 24 of the protective cap, the protective cap 20 is provided between the annular seal 34 and the dust lip 32 with a support bearing 40, which in this region ensures improved support of the protective cap 20 on the wiper shaft 8 and unilaterally transmits forces applied to the protective cap 20 into the wiper shaft 8.

In the protective cap 20 shown in FIG. 2, the support bearing 40 consists of a separate annular or sleeve-shaped bearing element 42 which is inserted into a cross-sectional widening 46 adjacent to the annular seal 34 which is open toward the recess 38. The cross-sectional widening 46 has a cross section which is complementary to the cross section of the bearing element 42, and may optionally have a slightly smaller diameter than the recess 38 for the annular seal 34.

The bearing element 42 consists of an annular body configured in one piece, for example made of sintered bronze or oil-impregnated sintered steel, the internal diameter thereof being slightly larger than the external diameter of the wiper shaft 8, and bears with its internal periphery against the external periphery of the rotating wiper shaft 8.

In the protective cap 20 shown in FIG. 3, the support bearing 40 is configured integrally with the protective cap 20, in other words it forms between the dust lip 32 and the annular seal 34 an integral part of the protective cap 20 which extends over a certain minimum length of approximately 5 to 10 mm, and in a similar manner to the aforementioned support element 42 has a slightly larger internal diameter relative to the external diameter of the wiper shaft 8.

Between the support bearing 40 and the dust lip 32, the through-opening 36 of the protective cap 20 still has a small cross-sectional widening, which conically tapers in the protective cap 20 of FIG. 2 from the cross-sectional widening in the direction of the dust lip 32, and in the protective cap 20 of FIG. 3 is formed by a peripheral groove 44 between the integral support bearing 40 and the dust lip 32. The groove 44 is expediently configured such that it serves as a grease chamber.

In the protective cap 20 shown in FIG. 4, the support bearing 40, as in the protective cap 20 of FIG. 2, consists of a rigid bearing element 42 inserted into a recess 46 of the protective cap 20, but said bearing element is arranged on the side of the annular seal 34 remote from the dust lip 32, said bearing element being held on its side remote from the annular seal 34 by the steel disc 48, pressed into or clipped into the protective cap. The diameter of the cross-sectional widening 46 corresponds in this case to the diameter of the recess 38.

1. A protective cap for a wiper shaft driven by a wiper drive of a window wiper arrangement, comprising a through-opening for the wiper shaft, with an annular seal introduced into the through-opening, as well as with a peripheral dust lip on the front end remote from the wiper drive, characterized by a support bearing (40) for supporting the protective cap (20) on a peripheral face of the wiper shaft (8).

2. The protective cap as claimed in claim 1, characterized in that the support bearing (40) is arranged between the dust lip (32) and the annular seal (34).

3. The protective cap as claimed in claim 1, characterized in that the support bearing (40) is arranged on the side of the annular seal (34) remote from the dust lip (32).

4. The protective cap as claimed in claim 1, characterized in that the support bearing (40) is adjacent to the annular seal (34).

5. The protective cap as claimed in claim 1, characterized in that the support bearing (40) extends over a length of at least 5 to 10 mm.

6. The protective cap as claimed in claim 1, characterized in that the support bearing (40) comprises an annular bearing element (42) made of a rigid material around the wiper shaft (8) introduced into the protective cap (20).

7. The protective cap as claimed in claim 6, characterized in that the bearing element (42) consists of a corrosion resistant material.

8. The protective cap as claimed in claim 6, characterized in that the bearing element (42) consists of a sintered metal.

9. The protective cap as claimed in claim 6, characterized in that the bearing element (42) is inserted into a cross-sectional widening (46) which is open toward the annular seal (34).

10. The protective cap as claimed claim 1, characterized in that the support bearing (40) forms an integral part of the protective cap (20).

11. The protective cap as claimed in claim 1, characterized by a peripheral groove (44) arranged between the dust lip (32) and the support bearing (40) and serving as a grease chamber.

12. The protective cap as claimed in claim 1, characterized by means (26, 28) for the non-positive and/or positive connection to the wiper drive (6).

13. A wiper drive for a window wiper arrangement, comprising a wiper shaft and a protective cap pushed onto the wiper shaft, which in the vicinity of its one front end is non-positively and/or positively connected to the wiper drive, at its other front end has a dust lip and between its two front ends is provided with an annular seal bearing against the peripheral surface of the wiper shaft, characterized in that the protective cap (20) between the dust lip (32) and the annular seal (34) has a support bearing (40) for supporting the protective cap (20) on the peripheral surface of the wiper shaft (8).
